(19) United States
(12) Patent Application Publication
(10) Pub. No.: US 2012/0025784 A1
(43) Pub. Date: Feb. 2, 2012

(54) Advanced Charge Balancing System for Lithium Batteries

(76) Inventor: Salim Rana, Calgary (CA)

(21) Appl. No.: 13/195,781

(22) Filed: Aug. 1, 2011

Related U.S. Application Data
(60) Provisional application No. 61/369,189, filed on Jul. 30, 2010.

(51) Int. Cl. H02J 7/00

(52) U.S. Cl. 320/134

(57) ABSTRACT

A method of balancing the terminal voltage across individual and multiple battery cells is described. To employ the method a lithium ion battery having at least two battery cells is provided along with an energy dispersing unit capable of taking energy from individual cells, stepping down individual voltages, and redirecting the voltage to the lowest voltage battery cell. The terminal voltage of individual cells is then monitored during discharge, and discharging cells having a greater terminal voltage are discharged in advance of cells having less terminal voltage. Thereafter establishing a charge algorithm wherein a differential curve is established under specific conditions, and charging current is applied complimentary to the differential curve.

This application claims the benefit of the filing date of provisional application No. 61/369,189, filed on Jul. 30, 2010.

### BACKGROUND

Advances in battery chemistry allow lithium batteries to carry more energy at a given mass. Like many other advanced in battery technology, lithium batteries have a unique set of challenges. In particular, battery cells must be monitored to ensure proper discharging and charging.

Typically, a battery management system (BMS) monitors parameters including cell voltage and temperature to ensure individual battery cells are maintained according to safe operating conditions. Overly discharging cells causes damage, while overcharged cells present an explosion risk.

Typical electric vehicle (EV) battery systems have anywhere from 80 to 96 individual lithium-ion cells. Because such a large number of cells are used, statistically, there is a higher failure rate than with conventional batteries having a single cell, or only a few cells.

Various battery management systems regulate charging and discharging in order to preserve cell charge within predetermined safe tolerances. In electric vehicle systems, it is optimal to maintain the same voltage across the entire system. Unfortunately, due to production variances, uneven temperature distribution and differences in the ageing characteristics of particular cells, it is very difficult to maintain the same voltage across a large number of cells. For this reason, there is a need for a system that balances the charge level in a battery comprising numerous cells, thereby preventing degradation in one cell from affecting the entire battery array. It is the purpose of this invention to disclose a method of charge balancing using a system that is both efficient and cost effective.

### SUMMARY

During a battery charging cycle, where numerous individual cells comprise the battery, if a degraded cell in the system has diminished capacity, the integrity of the array of cells is at risk of premature failure, and possibly an explosion. While discharging, the weakest cell has the greatest depth of discharge and tends to cause the battery management system to prematurely shut down charging before drawing the maximum usable energy from the entire battery system. The invention provides an efficient system of active cell balancing that removes charge from high voltage cells, delivering it to one or more low voltage cells.

### DESCRIPTION

Using the method, energy is taken from the entire battery pack (HV) and directed into a DC/DC system that steps the voltage down to a usable voltage level. This energy is then redirected to the lowest cell of the entire system. This system is more efficient because it redistributes energy rather than dissipating it as heat. The logic unit determines the lowest voltage cell and reconfigures its circuitry to redirect the excess energy.

The system consists of a single energy dispersing unit to be cost effective. The system first determines whether or not the battery system is discharging or charging and stores the location and the voltage reading of the lowest cell. It then uses a lookup table to determine the circuitry it needs to configure in order to re-route the energy to the lowest cell. These steps are then repeated until all cells are equally balanced. The procedure can be applied during discharging as well as charging.

In another embodiment of the invention, there are two major charging procedures. One is to charge at a constant current, and when a target voltage is reached, that voltage is kept constant until the current, which normally decreases, reaches a certain value. The second charging procedure is step charging with a constant current. In this manner, the current is stopped at predetermined time intervals until the target voltage is reached. It has been observed that lithium ion batteries are very sensitive in terms of charge rate, temperature, thermodynamics, and in the kinetics of all components, including electrodes and chemistries. By adjusting the voltage and current output to match the chemistry of lithium batteries, charge can be maximized.

More specifically, during charging, lithium ions leave the structure of the battery cathode material. Ionic movement is assisted by a salt, preferably LiPF₆ dissolved in EC/DMC solvent. If the charging rate is too high, the total capacity achieved is reduced. The extent of this reduction in total capacity depends on the c-rate. In one embodiment, large format prismatic cells having a capacity of 100 Ah are used during charging. In experiment using these types of cells, a differential curve was produced during charging as the cathode material underwent different phase transformations. In particular, several peaks are observed when data is plotted against dV/dt and V, wherein V represents voltage and t represents time.

During phase transformations, it was observed that within particular voltage ranges, the rate of increase in voltage is higher in some areas and lower in others. This phenomenon was introduced to a model charging algorithm and the system designed so that the charging current was varied according to cell voltage within the range of 3 to 4.2 volts. By varying the charging current thusly, the overall battery cycle life was increased and the percentage of capacity was greater compared to a non-variant charging procedure. Additionally, when using the varying charge technique, a lower rise in temperature is observed.

What is claimed is:

1. A method of balancing terminal voltage in multiple battery cells during charging and discharging, comprising the steps of:
a. providing at least two battery cells;
b. providing an energy dispersing unit capable of taking energy from individual cells, stepping down individual battery cell voltage and redirecting the voltage to the lowest voltage battery cell;
c. monitoring the terminal voltage of individual battery cells using the energy dispersing unit at predetermined intervals as the battery cells discharge; and
d. discharging cells having greater terminal voltage, while preventing the cell having the lowest terminal voltage from discharging.

2. The method of claim 1 wherein the circuit is a direct current circuit.

3. A method of charging lithium ion battery cells, comprising the steps of:
a. providing a lithium ion battery cell;
b. charging and discharging the battery cell under varying conditions, said conditions including charge rate, temperature, and component kinetics;
c. establishing a c-rate corresponding to specific charging conditions;
d. producing a differential curve by plotting dV/dt and V, where V represents voltage and t represents time;
e. establishing an algorithm that varies charge current according to the differential curve; and
f. charging the battery cell using variable charge current as established by the differential curve.

4. The method of charging lithium ion battery cells of claim 3, wherein the battery cell is a large format prismatic cell, having a capacity of 100 Ah.

5. The method of charging lithium ion battery cells of claim 3, wherein the charging current is varied according to cell voltage within the range of 3 to 4.2 volts.
